(19) United States
(12) Patent Application Publication
(10) Pub. No.: US 2003/0136058 A1
(43) Pub. Date: Jul. 24, 2003

(54) Method of allocating advertising space and system therefor

(76) Inventor: Andrew Winton, Darling Point NSW (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/314,116

(22) Filed: Dec. 6, 2002

(30) Foreign Application Priority Data
Dec. 7, 2001 (AU) PR9361

(51) Int. Cl. E04H 14/00; B66B 9/00; B44F 7/00

(52) U.S. Cl. 52/27; 52/29; 52/28; 52/38; 52/311.1; 52/316

(57) ABSTRACT

A system for the application of an image to an upper surface of a built structure, the image arranged for visibility from over-flying craft.

An upper surface of a built structure incorporating indicia thereon or therein; the indicia constructed so as to be discernable by observers in craft passing over the built structure when the craft is within a predetermined legibility distance of the built structure.

### RELATED APPLICATIONS

This application claims the benefit of Australian Provisional Patent Application No. PR9361 entitled “A METHOD OF ALLOCATING ADVERTISING SPACE & SYSTEM THEREFOR” filed Dec. 7, 2001.

### BACKGROUND

The present invention relates to the commercialization and application of images on roof surfaces for the purpose of advertising products, services, corporate names or the like to viewers in over-flying craft or the like.

In the competitive world of advertising there is a continual search for available space which may be used to bring a product, service or corporate name to the attention of the public. In many cases this drive to advertise has led to an overcrowding of signage in public places, often to the detriment of the environment and a devaluation of impact of an individual advertising image.

It is an object of the present invention to address or ameliorate one or more of the abovementioned disadvantages or at least provide a useful alternative.

### BRIEF DESCRIPTION OF THE INVENTION

In this specification the term “craft” is to be interpreted broadly to include most if not all forms of device for conveying persons above or over the top of built structures. In particular forms this will include aircraft.

Accordingly, in one broad form of the invention there is provided a system for the application of an image to an upper surface of a built structure, said image arranged for visibility from over-flying craft.

Preferably said upper surface comprises a rooftop.

Preferably characteristics of said image define a cone of legibility. Preferably said image is displayed for a predetermined time at a predetermined revenue rate.

Preferably said image is displayed for a time period in the range of 1 to 12 months.

Preferably said image is displayed for a time period in the range of 1 to 5 years.

Preferably said image is displayed for a time period in the range of 1 to 10 years.

Preferably said image is in the form of a company name or logo.

Preferably said image is displayed in the form of an advertisement for a product or service.

Preferably the step of commercialization includes leasing of space on said rooftops.

Preferably said space is made available on a commercial basis to third parties for the display of advertising indicia thereon.

Preferably said image is displayed in the form of textual or graphic information.

Preferably said image comprises a series of images displayed consecutively.

Preferably said image is a moving image.

Preferably said image is applied as a film.

Preferably said image is applied by way of projection onto said rooftops.

Preferably the subtended angle of said cone is determined according to a parameter based on roof surface texture and discontinuities of the roof surface.

Preferably the commercial value of an advertisement applied to said rooftops is a function of the cone of legibility.

Preferably commercial value of said image is a function of the number and characteristics of aircraft flight paths intersecting said cone.

Preferably each said image is applied as paint by an applicator adapted to traverse a roof surface.

Preferably each said image is formed from an array of coloured panels, segments, dots or pixels.

Preferably the panels, segments, dot or pixel size and spacing is determined according to information theory.

Preferably the resolution of each said image allows for roof discontinuities such as sky lights.

Preferably the resolution of each said image allows for roof discontinuities such as changes of roof angle.

Preferably each said image is provided with day and/or night time illumination.

Preferably said applicator is in modular form arranged to be lifted to a rooftop in sections for reassembly.

Preferably the applicator is provided with traversing means for progressively applying an image to a roof surface.

Preferably said applicator is provided with a rail system arranged to guide said applicator over an expanse of roof.

Preferably the applicator is provided with support wheels and propulsion means.

Preferably the applicator is provided with a plurality of paint, toner or ink dispensing nozzles disposed along an axis transverse to the direction of the guide rails of the applicator.

Preferably the applicator is provided with digital and/or mechanical control means.

Preferably the control means determines the sequence, colour, duration and the nozzle from which paint, toner or ink is dispensed.

Preferably the pixel panel, segment or dot size delivered by the nozzles may be varied according to the required resolution of the image to be applied.

In yet a further broad form of the invention there is provided a method of allocating advertising space, the method comprising the steps of:

(a) Procuring a roof surface and obtaining signage rights to the roof surface;

(b) Offering the roof surface as a platform for advertising indicia for a predetermined period of time;

(c) Procuring the application of the advertising indicia in such manner as to be observable from over flying aircraft.

In yet a further broad form of the invention there is provided an upper surface of a built structure incorporating indicia thereon or therein; said indicia constructed so as to be discernable by observers in craft passing over said built structure when said craft is within a predetermined legibility distance of said built structure.

Preferably said predetermined legibility distance is in the range 100-2 000 feet.

Preferably said predetermined legibility distance is in the range 100-10 000 feet.

Preferably said predetermined legibility distance is in the range 30 000-40 000 feet.

Preferably said predetermined legibility distance is defined by and lies within the volume of a cone of legibility.

Preferably said built structure is a roof.

Preferably said built structure is a pontoon.

In yet a further broad form of the invention there is provided a method of deriving revenue from advertising space, the method comprising the steps of: procuring an upward facing surface and obtaining signage rights to the surface; offering to a third party the surface as a platform for advertising indicia for a predetermined period of time; procuring the application of the advertising indicia to said surface in such manner as to be observable from craft passing over said surface at a predetermined legibility distance.

Preferably said revenue is directly linked to the benefit derived by said third party from the visibility and discernability of said indicia to viewers in said craft as it passes over said surface at said predetermined legibility distance.

In yet a further broad form of the invention there is provided a surface to which the above method is applied.

### BRIEF DESCRIPTION OF THE DRAWINGS

FIG. 1 is an illustration of a roof top displaying an image as it may be seen from an aircraft in accordance with a first preferred embodiment of the present invention.

FIG. 2 shows a cone of visibility relative to the roof and image of FIG. 1.

FIG. 3 is a perspective view of an image applicator traversing a roof section for the creation of an image of the type shown in FIG. 1.

FIG. 4 is an illustration of a relationship between the effective areas of pixels and interpixel spacing as used to form an image of the type shown in FIG. 1,

FIG. 5 is a flow chart of an exemplary leasing/renting procedure for use in accordance with a particular example of embodiments of the present invention,

FIG. 6 is a flow chart of a valuation method in accordance with an example of embodiments of the present invention,

FIG. 7 is a flow chart of an advertiser valuation method in accordance with a further example of embodiments of the present invention, and

FIG. 8 illustrates an application of an example of the present invention to a floating pontoon in association with an adjacent airport facility.

### DETAILED DESCRIPTION OF PREFERRED EMBODIMENTS

Embodiments of the invention will now be described in detail with reference to the accompanying drawings.

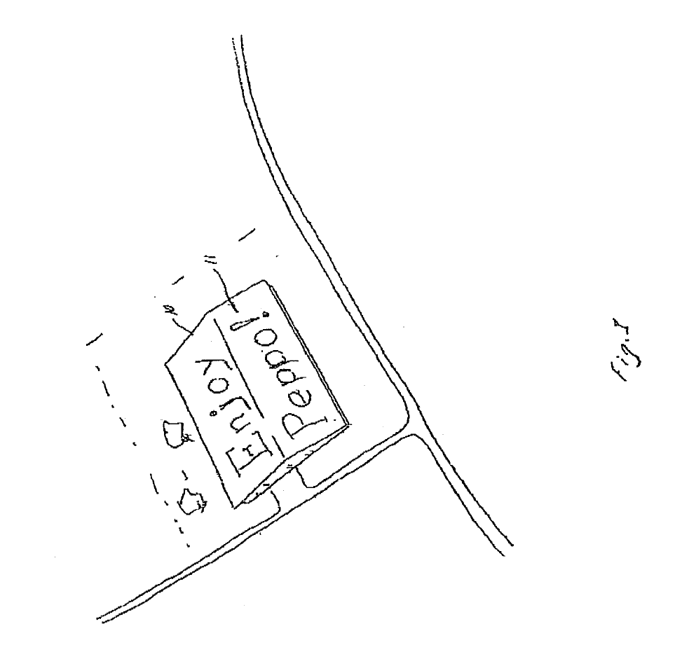

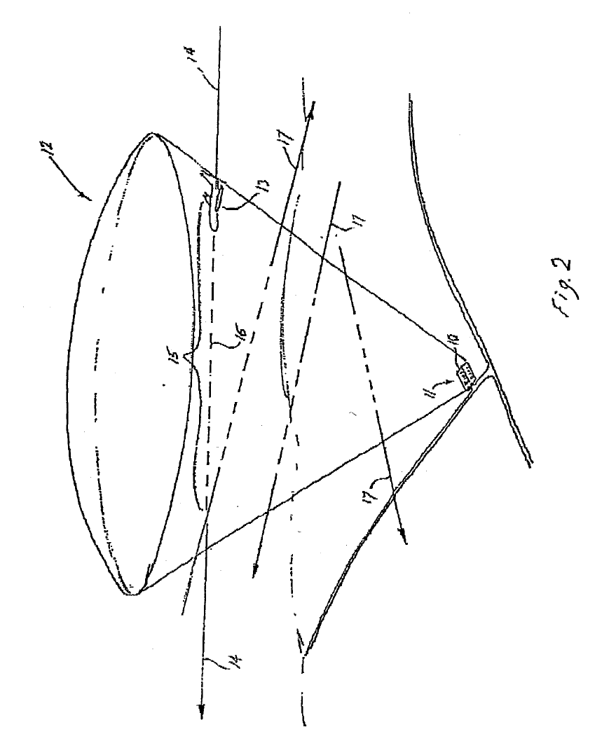

In FIG. 1 a roof 10 has an image 11 applied to it. Roof 10 is oriented such that its surface is readily visible from an aircraft 13 flying a path through a “cone of legibility” 12 as shown in FIG. 2.

The cone of legibility 12 is a function of the smallest discrete detail which is considered useful to the impact and intelligibility of the image 11. The dimension of the cone is then determined by the distance at which the unaided human eye can resolve that detail.

In one form, cone 12 is an inverted conical section of a sphere whose generator is equal to the distance of resolution of the smallest discrete detail of the image 11. The subtended angle of the cone is also determined by the minimum inclination at which the image can be resolved. The determination of the angle may include a parameter based on the nature of the roof surface and discontinuities of that surface.

The apex of the cone is centered on the image. FIG. 2 shows a cone of legibility 12 relative to roof 10 and image 11 with an aircraft 13 on flight path 14 intersecting the cone for a distance 15 as shown by dashed line 16. Also in FIG. 2 are shown other flight paths 17 which are known to pass through the cone.

The size of the cone of legibility, the number of flight paths, number and types of aircraft passing through the cone as well as the duration of each such passage, are contributing factors to the commercial value of the image.

In use, the commercial value of a roof space and a proposed image may be calculated from the cone of legibility, local flight paths intersecting the cone, flight frequencies and durations, types of aircraft and other relevant data.

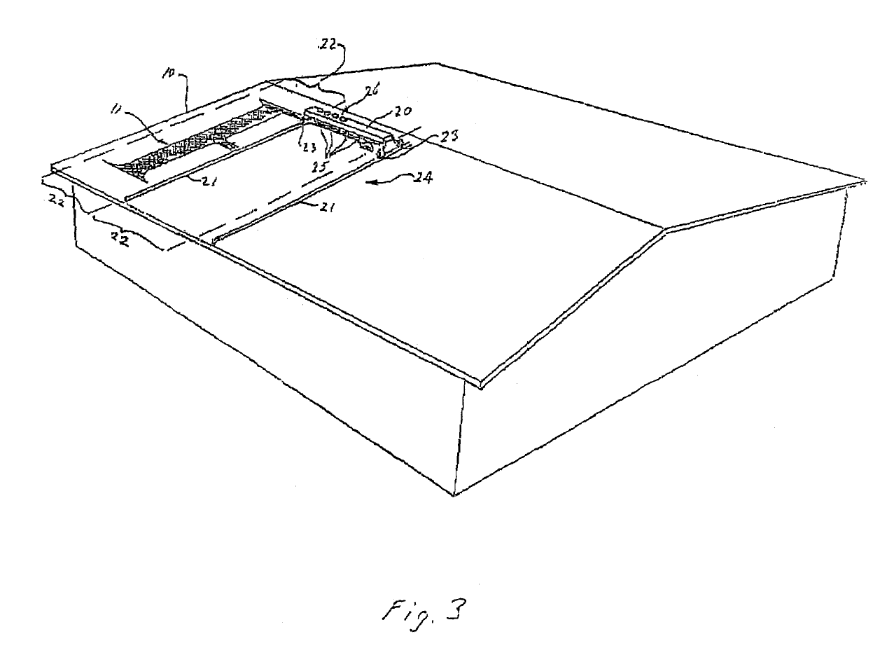

FIG. 3 illustrates the general principle according to which an image may be applied to a roof surface 10. An applicator 20 is arranged to follow a parallel rail system 21. Rail system 21 is relocated to allow respective bands 22 of image 11 to be applied.

In a preferred embodiment applicator 20 is in the form of a beam structure straddling the guide rails 21 comprising rail system 24 and provided with support wheels 23 and drive means to propel the applicator along the guide rails. The beam structure is provided with a plurality of nozzles 25, paint reservoirs 26 and control means to direct paint to selected nozzles according to a control program based on the digitized image to be applied.

In a further preferred embodiment the applicator is of modular construction to allow it to be lifted to the roof in sections. Its modular construction is further adapted to allow multiples of beam segments to be joined together to provide various lengths of beam to suit different roof and image sizes.

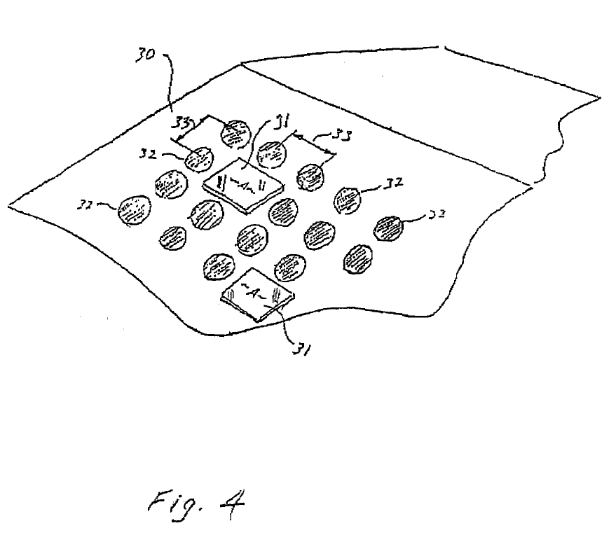

In a further preferred embodiment the image is made up of pixels. The pixel size and interpixel spacing are determined according to the principles of information theory and are functions of the roof size and image detail as well as discontinuities in the roof surface. By way of a non limiting example, FIG. 4 illustrates some of these relationships where a roof surface 30 has discontinuities in the form of skylights 31 of surface area “A”. Pixels 32 are then selected as having surface area A/2 with interpixel spacing 33 a percentage of pixel diameter “D”.

In use, the image to be applied is digitized and segmented into parallel bands 22, if required, for an applicator to cover the surface area of the image. By means of software, the digitized image is translated into a control program for the dispensing of different coloured paints from the applicator nozzles as it traverses a roof section.

Also in use in commercial applications a typical commercial implementation involves the steps of:

1. Procuring a roof surface and obtaining signage rights to the roof surface;

2. Offering the roof surface as a platform for advertising indicia for a predetermined period of time;

3. Procuring the application of the advertising indicia in such manner as to be observable from over flying aircraft.

The above describes only some embodiments of the present invention and modifications, obvious to those skilled in the art, can be made thereto without departing from the scope and spirit of the present invention.

For example, it is to be understood that the image to be applied to the rooftop can be applied in many ways other than by direct physical application. For example, the image may be applied indirectly as a separate layer overlaid upon the rooftop. In alternative forms the image may be applied indirectly by, for example, the projection of light onto the rooftop.

In yet other forms the image may be applied as an “active” image, which is to say in the form of a light emitting system such as can be provided by an array of lights, a CRT panel or the like.

Furthermore, analogous built structures may act effectively as rooftops for the purpose of forming a base for advertising display of the kind envisaged in this specification.

Specific examples of implementations of procedures compatible with one or more of the described embodiments will now be provided in detail:

### EXAMPLE 1

### Method of Deriving Revenue

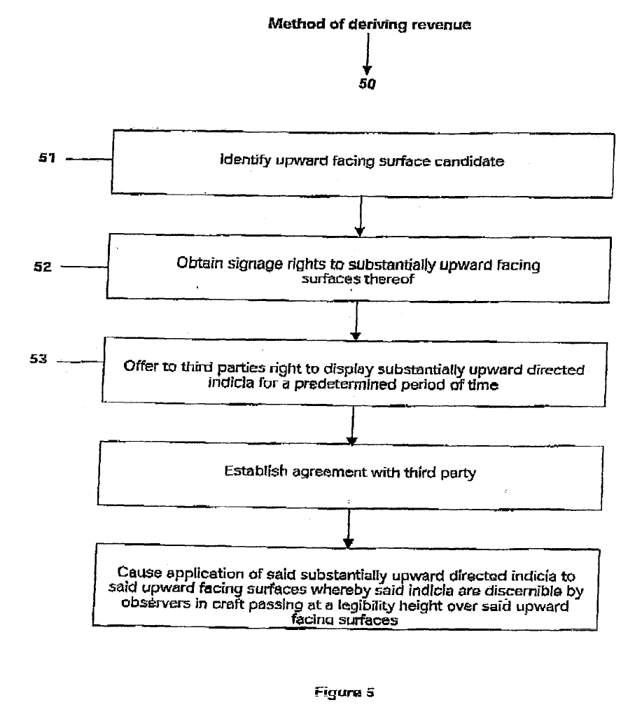

With reference to FIG. 5 a basic renting/leasing procedure is demonstrated in block diagram form.

In this arrangement the steps in a method 50 of deriving revenue from an upward facing surface are put into effect by the following steps:

In a first step 51 an upward facing surface is identified as a potential candidate to receive indicia thereon for viewing at a legibility distance by observers in an overflying craft. In typical instances this upward facing surface may be located near an airport but can be located elsewhere subject only to satisfying the basic requirement that the surface can be viewed by overflying craft and that indicia can be applied in a way such that they are made visible and discernable to observers in the craft looking down upon the upward facing surface and, more particularly, the indicia thereon.

In second step 52 signage rights are negotiated to the upward facing surface. In some instances it may be that the surface is, for example, a rooftop surface which already has a substantially vertically disposed sign thereon adapted for viewing from ground level. Any rights third parties may have to the substantially vertically disposed signage can be thought of as completely independent from rights to be negotiated for the substantially upward facing surfaces upon which, indeed, the substantially vertical sign may sit. It is conceivable in some instances that the substantially vertically oriented sign may remain and not interfere with indicia placed on the upward facing surfaces and for which separate signage rights may be negotiated in accordance with step 52.

Having negotiated signage rights both rights can be offered to third parties in a third step 53, usually for a predetermined period of time.

Once these basic steps have been performed agreement with the third party can be formalized and then given effect by causing the application of substantially upwardly directed indicia to the upward facing surfaces whereby the indicia are discernable by observers in craft passing over the upward facing surfaces at a legibility height.

### EXAMPLE 2

### Value to an Advertiser

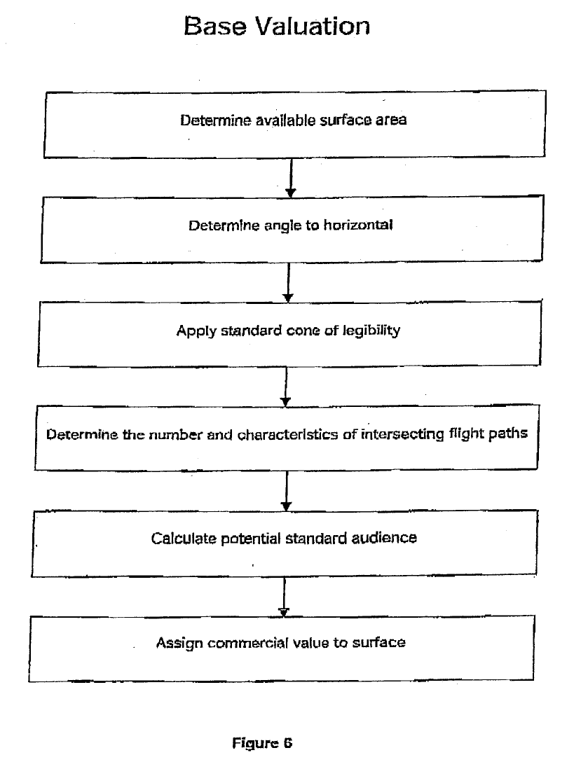

With reference to FIG. 6 a surface available for advertising purposes has a surface area Am² and is angled at α° to the horizontal. A potential client wishes to display a certain logo in the form of a text string which, to fit in the available area, demands that the letters of the logo have a maximum height of x meters.

Several factors then need to be taken into account in determining the maximum resolution distance and maximum angle of inclination to the roof surface at which the logo can be resolved by the naked eye including:

a) the maximum text height,

b) the colours of the logo text and background to give a contrast factor,

c) the texture and any discontinuities of the roof surface or the texture of sheeting or other media (if the logo is not to be applied directly to the existing roof surface).

These parameters of distance and angle may be determined empirically by reference for example to suitable computer modeling of the logo and roof surface area with scaling and spatial rotation of the image to simulate its appearance and legibility at various viewing distance and angles.

With these parameters established the cone of legibility is defined and any intersecting flight paths, their frequencies and passenger densities may be determined. The value then of the roof space for advertising purposes can be calculated on the basis of the number of potential viewers over a given period.

Not all potential viewers need be valued equally however; for example a large passenger jet passing through the cone on a descent towards landing at an average height of 500 ft will have greater value than a similar jet passing through the cone at for example 5,000 ft even if the passengers of both jets would be able to resolve the logo.

Furthermore, the cone of legibility may contain flight paths which are curved and during the transit of which an aircraft is banked so as to afford the maximum viewing potential of the rooftop to at least half of its passengers.

Thus scaling factors may be introduced which take account of the actual average distance from the roof and the benefits of any curvature of a flight path as inputs into the calculations of the value of an advertising space.

In this example the valuation is performed for the benefit of the potential advertiser in that an assessment may now be made as to whether the cost of leasing the space is warranted in view of the potential audience which may view the advertiser's logo over the period of the lease.

### EXAMPLE 3

### Value to a Leasing Agent and Surface Owner

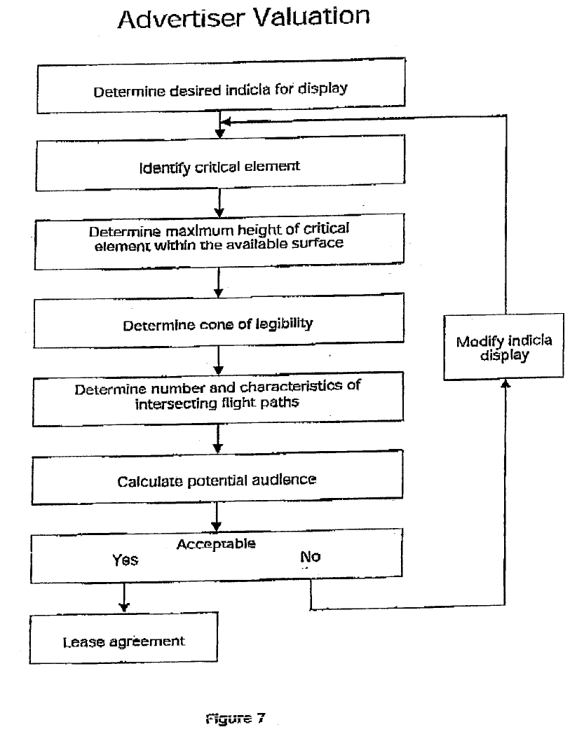

With reference to FIG. 7 clearly, the larger the indicia applied to a given surface the larger will be the cone of legibility and the potential viewing audience, other factors being equal. Therefore the method performed in Example 1 may not confer an adequate value on the surface area offered if the cone of legibility is relatively small because of small indicia specified by the advertiser.

For the purpose of assigning a base value to a given available surface area, a leasing agent may perform a similar operation as described in Example 1 but use a cone of legibility based on a standard indicia size applied to a standard surface. By applying this “standard cone” to the available surface, the potential viewing audience is ascertained from the number and characteristics of flight paths through the cone and so establish a market value for the surface.

### EXAMPLE 4

### Floating Surface

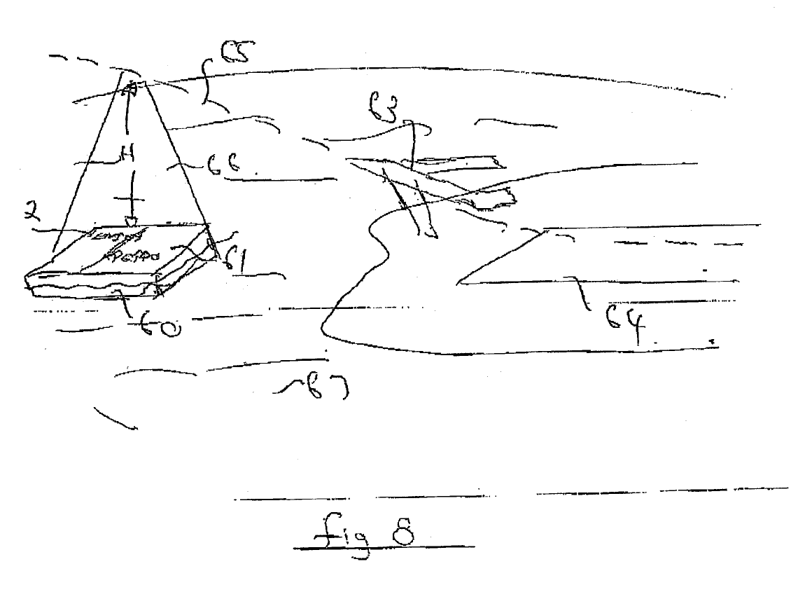

With reference to FIG. 8, by way of an example intended to clarify the breadth of meaning to be given to the term “built structure” and “roof” in this specification there is illustrated a built structure 60 in the form of a pontoon or like floating structure having a substantially upwardly directed surface 61 upon which or into which indicia 62 can be inscribed and sized so as to be visible to observers in an overflying craft, in this instance aeroplane 63 during a take off or landing phase from runway 64 and following trajectory 65 which has associated with it a cone of legibility 66 associated with indicia 62 which permits the discernment of the indicia 62 by the passengers or other persons in aeroplane 63. This particular example can be used with airports which lie adjacent bodies of water 67 as shown in this example.

The predetermined legibility distance H inherent in the cone of legibility 66 associated with flight path 65 can, for example, lie in the range 100-2 000 feet. In alternative arrangements the predetermined legibility distance can be in the range 100-10 000 feet. In yet alternative arrangements the legibility distance H can be the typical cruising height range for an aircraft, typically in the range 30 000-40 000 feet.

1. A system for the application of an image to an upper surface of a built structure, said image arranged for visibility from over-flying craft.

2. The system of claim 1 wherein said upper surface comprises a rooftop.

3. The system of claim 1 or claim 2 wherein characteristics of said image define a cone of legibility.

4. The system of any previous claim wherein said image is displayed for a predetermined time at a predetermined revenue rate.

5. The system of claim 4, wherein said image is displayed for a time period in the range of 1 to 12 months.

6. The system of claim 4, wherein said image is displayed for a time period in the range of 1 to 5 years.

7. The system of claim 4, wherein said image is displayed for a time period in the range of 1 to 10 years.

8. The system according to any previous claim wherein said image is in the form of a company name or logo.

9. The system of any previous claim wherein said image is displayed in the form of an advertisement for a product or service.

10. The system of any previous claim wherein the step of commercialization includes leasing of space on said rooftops.

11. The system of claim 10 wherein said space is made available on a commercial basis to third parties for the display of advertising indicia thereon.

12. The system of any previous claim wherein said image is displayed in the form of textual or graphic information.

13. The system of any previous claim wherein said image comprises a series of images displayed consecutively.

14. The system of any previous claim wherein said image is a moving image.

15. The system of any previous claim wherein said image is applied as a film.

16. The system of any previous claim wherein said image is applied by way of projection onto said rooftops.

17. The system of claim 3 wherein the subtended angle of said cone is determined according to a parameter based on roof surface texture and discontinuities of the roof surface.

18. The system of claim 3 or 17, wherein the commercial value of an advertisement applied to said rooftops is a function of the cone of legibility.

19. The system of claim 3 wherein the commercial value of said image is a function of the number and characteristics of aircraft flight paths intersecting said cone.

20. The system of any previous claim wherein each said image is applied as paint by an applicator adapted to traverse a roof surface.

21. The system of any previous claim wherein each said image is formed from an array of coloured panels, segments, dots or pixels.

22. The system of claim 21, wherein the panels, segments, dot or pixel size and spacing is determined according to information theory.

23. The system of any previous claim wherein the resolution of each said image allows for roof discontinuities such as sky lights.

24. The system of any previous claim wherein the resolution of each said image allows for roof discontinuities such as changes of roof angle.

25. The system of any previous claim wherein each said image is provided with day and/or night time illumination.

26. The system of claim 20 wherein said applicator is in modular form arranged to be lifted to a rooftop in sections for reassembly.

27. The system of claim 20 or 26 wherein the applicator is provided with traversing means for progressively applying an image to a roof surface.

28. The system of claims 20 wherein said applicator is provided with a rail system arranged to guide said applicator over an expanse of roof.

29. The system of claim 20 wherein the applicator is provided with support wheels and propulsion means.

30. The system of claims 20 to 29 wherein the applicator is provided with a plurality of paint, toner or ink dispensing nozzles disposed along an axis transverse to the direction of the guide rails of the applicator.

31. The system of any one of claims 20 to 30 wherein the applicator is provided with digital and/or mechanical control means.

32. The system of claim 31 wherein the control means determines the sequence, colour, duration and the nozzle from which paint, toner or ink is dispensed.

33. The system of claim 30 wherein the pixel panel, segment or dot size delivered by the nozzles may be varied according to the required resolution of the image to be applied.

34. A method of allocating advertising space, the method comprising the steps of:
(a) Procuring a roof surface and obtaining signage rights to the roof surface;
(b) Offering the roof surface as a platform for advertising indicia for a predetermined period of time;
(c) Procuring the application of the advertising indicia in such manner as to be observable from over flying aircraft.

35. A method for the valuation of a surface for advertising purposes, said method comprising the steps of:
(a) determining the area of the surface available,
(b) determining the angle of said surface to the horizontal plane,
(c) determining a factor for the surface texture of the space or media to which advertising indicia is to be applied,
(d) determining the maximum size of elements of the indicia to be displayed,
(e) determining the maximum distance and inclination angle at which said elements of the indicia may be resolved by the unaided eye,
(f) determining the spatial orientation and extent of a cone of legibility, said cone having an axis centred on the surface and normal to said surface,
(g) determining the number and characteristics of any flight paths intersecting said cone of legibility.

36. The method of claim 35 wherein said step for the determination of said cone of legibility further includes the steps of:
(a) the construction of a 3-dimensional computer model of said surface area,
(b) positioning a digital representation of said indicia on said model of said surface area,
(c) empirically determining the parameters of maximum distance and angle of inclination at which said indicia may be resolved by the scaling and spatial rotation of the computer model.

37. An upper surface of a built structure incorporating indicia thereon or therein; said indicia constructed so as to be discernable by observers in craft passing over said built structure when said craft is within a predetermined legibility distance of said built structure.

38. The upper surface of claim 37 wherein said predetermined legibility distance is in the range 100-2 000 feet.

39. The upper surface of claim 37 wherein said predetermined legibility distance is in the range 100-10 000 feet.

40. The upper surface of claim 37 wherein said predetermined legibility distance is in the range 30 000-40 000 feet.

41. The upper surface of claim 37 wherein said predetermined legibility distance is defined by and lies within the volume of a cone of legibility.

42. The upper surface of claim 37 wherein said built structure is a roof.

43. The upper surface of claim 37 wherein said built structure is a pontoon.

44. A method of deriving revenue from advertising space, the method comprising the steps of: Procuring an upward facing surface and obtaining signage rights to the surface; offering to a third party the surface as a platform for advertising indicia for a predetermined period of time; procuring the application of the advertising indicia to said surface in such manner as to be observable from craft passing over said surface at a predetermined legibility distance.

45. The method of claim 44 wherein said revenue is directly linked to the benefit derived by said third party from the visibility and discernability of said indicia to viewers in said craft as it passes over said surface at said predetermined legibility distance.

46. A surface to which the method of claim 44 or 45 is applied.
